(19) United States
(12) Patent Application Publication
(10) Pub. No.: US 2017/0080355 A1
(43) Pub. Date: Mar. 23, 2017

(54) COLUMN SETTLER FOR HIGH PERFORMANCE LIQUID/LIQUID PHASE SEPARATIONS IN HYDROMELLURCIAL PROCESSES AND METHODS THEREOF

(71) Applicants: Frank BACZEK, Midvale, UT (US); FLSmidth A/S, Valby (DK)

(72) Inventors: Frank Baczek, Salt Lake City, UT (US); David J. Chaiko, South Jordan, UT (US); Vishal Gupta, Sandy, UT (US); Suma Kandagatla, Surrey (CA); Bryan Potratz, Midvale, UT (US); Gary Roy, Salt Lake City, UT (US)

(21) Appl. No.: 15/120,239

(22) PCT Filed: Feb. 16, 2015
(86) PCT No.: PCT/US15/16022

§ 371 Date: Aug. 19, 2016

Related U.S. Application Data
(60) Provisional application No. 61/942,352, filed on Feb. 20, 2014.

(51) Int. Cl. B01D 11/04; B01D 17/02; B01D 17/04

(52) U.S. Cl. CPC B01D 11/0457; B01D 17/041; B01D 11/048; B01D 17/0211

(57) ABSTRACT

A mixer settler system is disclosed. The system comprises a mixer [110] configured for receiving an organic phase and an aqueous phase, the mixer [110] being further configured to maintain the organic phase and the aqueous phase in a single unstable emulsion phase, wherein mass transfer occurs between said organic phase and said aqueous phase; and, a column settler [120] which is configured to receive a single unstable emulsion phase from the mixer [110] via an emulsion inlet [125] and is also configured to separate the single unstable emulsion phase into a stable organic phase and a stable aqueous phase by virtue of coalescence; the column settler further comprising an organic outlet [121] above the emulsion inlet [125] and an aqueous outlet [123] below the emulsion inlet [125]; the column settler [120] further discouraging mass transfers within the unstable emulsion phase and further promoting coalescence of each of said stable organic phase and stable aqueous phase. A method of settling two immiscible liquids is further disclosed. The method comprises providing a mixer [110] configured for receiving an organic phase and an aqueous phase; maintaining the organic phase and the aqueous phase in a single unstable emulsion phase using the mixer [110], wherein mass transfer occurs between said organic phase and said aqueous phase; providing a column settler [120] which is configured to receive a single unstable emulsion phase from the mixer [110]; sending the single unstable emulsion phase to the column settler [120]; and separating the single unstable emulsion phase into a stable organic phase and a stable aqueous phase within the column settler [120] by virtue of coalescence.

### FIELD OF THE INVENTION

This invention relates to settling devices such as mixer settlers commonly used in solvent extraction processes, and more particularly to systems for and methods of quickly settling an organic phase from an aqueous phase, and vice-versa with minimal footprint and high throughput.

### BACKGROUND OF THE INVENTION

Mixer settlers are a class of mineral process equipment used in solvent extraction processes. Mixer settlers generally consist of a first stage that mixes two immiscible phases together, followed by a quiescent settling stage that allows the phases to separate by gravity.

To this end, bulky mixer settlers require, on average, larger than 15×30×1 meter settling stage equipment, and up to three pieces of mixer stage equipment (e.g., primary and auxiliary mixers). Each stage of the mixer stage performs a combined pumping and mixing action. Use of multiple stages allows a longer reaction time and also minimizes the short circuiting of unreacted material through the mixers. The settling stage is massive, requires very large footprints, and requires long distances of piping and tubing, therefore increasing manufacturing costs.

Mass transfer devices, such as the ones shown in U.S. Pat. Nos. 4,657,401, 4,595,571, 4,391,711, 5,466,375, 4,292,277, 4,221,658, and 801,679 do not promote settling, but are instead intended to keep two immiscible fluid phases suspended in a single unstable emulsion phase. For example, in U.S. Pat. No. 4,657,401, the unstable emulsion phase is maintained within a column, and then moved to the top, where it exits and enters a separate settler unit. As another example, in U.S. Pat. No. 4,595,571, the unstable emulsion phase is maintained within a column, and then moved to the top, where it exits and enters a separate settler unit. In another example, in U.S. Pat. No. 4,391,711, a column is effected for liquid-liquid contact, rather than separating two immiscible liquids. In yet a further example, U.S. Pat. No. 5,466,375, shows a liquid-liquid extraction apparatus which is optimized for effecting liquid-liquid contact, rather than separating two immiscible liquids. Another example, is shown in U.S. Pat. No. 4,292,277, wherein a column is a Liquid-liquid contacting column which is designed for and promoting mass transfer which is necessary for extraction, rather than for quiescing, settling, and effecting separation of two mixed liquid phases. Additionally, U.S. Pat. No. 4,221,658 also discusses mixing within a column (not settling an emulsion phase entering a column), wherein mixing effects liquid-liquid contact between an aqueous medium and an organic hydrophobic liquid medium. Moreover, in U.S. Pat. No. 801,679, a number of liquid separations are effected based on density, rather than by a combination of density and hydrophobicity as with the present invention.

### OBJECTS OF THE INVENTION

It is, therefore, an object of the invention to provide an improved settler which reduces the necessary footprint area for a solvent extraction process.

It is another object of the invention to provide a faster, shorter residence time for coalescence.

It is another object of the invention to provide a system which has a higher throughput than conventional systems.

It is another object of the invention to provide a system for coalescing which reduces or eliminates entrainment, and hence, reduces or eliminates crud formation.

It is yet another object of the invention to provide a significantly improved method of settling two immiscible fluid phases which are suspended in a single unstable emulsion phase.

It is a further object of the invention to provide a design which can be applied across many solvent extraction processes as well as other non-related processes.

These and other objects of the invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

As will be discussed herein, the present invention includes improved methods of coalescing an emulsion of two immiscible fluids, particularly within mixer settlers. In particular, a mixer settler system is disclosed. The mixer settler system comprises a mixer configured for receiving an organic phase and an aqueous phase, the mixer being further configured to maintain the organic phase and the aqueous phase in a single unstable emulsion phase, wherein mass transfer occurs between said organic phase and said aqueous phase. The mixer settler system further comprises a column settler which is configured to receive a single unstable emulsion phase from the mixer via an emulsion inlet and also configured to separate the single unstable emulsion phase into a stable organic phase and a stable aqueous phase by virtue of coalescence. The column settler may further comprise an organic outlet above the emulsion inlet and an aqueous outlet below the emulsion inlet. The column settler may be further configured to discourage mass transfers within the unstable emulsion phase. The column settler may be further configured for promoting coalescence of each of said stable organic phase and stable aqueous phase.

The column settler may further be provided with gentle agitation means. In some embodiments, the gentle agitation means may comprise at least one baffle. The at least one baffle may be round, helical, flat, vertically oriented, or oriented at an angle. In some embodiments, the at least one baffle may comprise a solid portion and at least one open portion. The at least one open portion may be round, elongated, or may comprise a slot or slit, without limitation. The at least one baffle may comprise a plurality of open portions. In some embodiments, the gentle agitation means may comprise reciprocating means. The reciprocating means may comprise a shaft that moves axially up and down within said column settler. In some embodiments, the shaft may comprise one or more baffles. In yet further embodiments, the gentle agitation means may comprise slow rotation means. In some embodiments, the slow rotation means may comprise a shaft that is configured to slowly move in a clockwise or counter clock-wise direction within the column settler. The shaft may slowly move in a clockwise and then slowly in a counter clock-wise direction within said column settler, according to some embodiments. According to some embodiments, the gentle agitation means may further comprise slow rotation means and reciprocating means. Preferably, the gentle agitation means does not form an emulsion, maintain an emulsion, or facilitate mass transfer, but rather improves coalescence of immiscible phases within the settling column.

A method of settling two immiscible liquids is further disclosed. The method comprises providing a mixer configured for receiving an organic phase and an aqueous phase; maintaining the organic phase and the aqueous phase in a single unstable emulsion phase using the mixer, allowing mass transfer to occur between said organic phase and said aqueous phase while in the mixer; providing a column settler downstream of the mixer which is configured to receive a single unstable emulsion phase from the mixer; sending the single unstable emulsion phase to the column settler; and, separating the single unstable emulsion phase into a stable organic phase and a stable aqueous phase within the column settler by virtue of coalescence.

In preferred embodiments, the column settler may further comprise an organic outlet above an emulsion inlet and an aqueous outlet below the emulsion inlet. The method may also comprise the step of discouraging mass transfers within the unstable emulsion phase after the unstable emulsion phase enters the column settler. The method may further comprise the step of promoting coalescence of each of said stable organic phase and stable aqueous phase. Moreover, the method may comprise the step of separating the single unstable emulsion phase into a stable organic phase and a stable aqueous phase within the column settler using gravity. According to certain embodiments, the step of separating the single unstable emulsion phase into a stable organic phase and a stable aqueous phase within the column settler by virtue of coalescence comprises applying gentle agitation within the column settler. The gentle agitation may comprise reciprocation of a shaft that moves axially up and down within said column settler. The shaft may comprise one or more baffles that also move axially up and down within said column settler. The one or more baffles may comprise one or more open portions. In some embodiments, the step of applying gentle agitation comprises slowly rotating a shaft. In some embodiments, the step of slowly rotating a shaft further comprises slowly rotating a shaft in a clockwise and/or counter clock-wise direction within said column settler. In some embodiments, the slowly rotating shaft may comprise one or more baffles. In some embodiments, the step of applying gentle agitation may comprise slowly rotating a shaft in a clockwise direction for a duration, stopping the clockwise rotation, and then slowly rotating the shaft in a counter clock-wise direction within said column settler. In some embodiments, the step of applying gentle agitation may comprise slowly rotating an inner shaft clockwise and simultaneously rotating an outer shaft counter-clockwise. In some embodiments, the step of applying gentle agitation may comprise slowly rotating an inner shaft clockwise or counter-clockwise and not moving or otherwise rotating an outer shaft. In some embodiments, the step of applying gentle agitation may comprise slowly rotating an outer shaft clockwise or counter-clockwise and not moving or otherwise rotating an inner shaft. In some embodiments, the method may comprise reversing the direction of an inner shaft and an outer shaft. The inner shaft and/or outer shaft may comprise one or more baffles. In some embodiments, the step of applying gentle agitation within the column settler may comprise both slow rotation and reciprocation of a shaft, for instance, using a piston to move the shaft axially.

In some embodiments, a rotating and/or reciprocating shaft may comprise one or more baffles. In some embodiments, the step of applying gentle agitation within the column settler may comprise providing one or more stationary baffles to portions of the column. In some embodiments, the step of applying gentle agitation within the column settler may further comprise slow rotation and/or reciprocation of a shaft adjacent to said stationary baffles.

In some embodiments, a mixer settler system may comprise a spiral downcomber or centrifugal coalescer, and a mixer configured for receiving an organic phase and an aqueous phase; wherein the mixer may be further configured to maintain the organic phase and the aqueous phase in a single unstable emulsion phase, wherein mass transfer may occur between said organic phase and said aqueous phase. According to some embodiments, the mixer settler system may further comprise a column settler. According to some embodiments, the mixer settler system may further comprise a pre-conditioner, for example, a pre-conditioner comprising a tank and an inlet feed pipe, and a lower outlet pipe. In some embodiments, for example, the tank of the pre-conditioner may comprise a cyclonic head tank, and the inlet feed pipe of the pre-conditioner may comprise an volute feed pipe. In some embodiments, a column settler may comprise a flared column tank wall. The flared column tank wall may, in some embodiments, flare outwardly at its ends (FIG. 17). In some embodiments, the flared column tank wall may narrow at its ends (FIG. 18).

### BRIEF DESCRIPTION OF THE DRAWINGS

FIG. 1 shows a mixer-settler system 100 according to some embodiments;

FIGS. 2-4 are detailed views of middle, lower, and upper portions of the column settler 120 of FIG. 1, respectively;

FIG. 5 is a perspective isometric view of a baffle 124 shown in FIGS. 1-4, and according to some non-limiting embodiments;

FIG. 6 shows a shaft 132 and baffle 134 arrangement for a column settler 120 according to some non-limiting embodiments;

FIG. 7 shows a shaft 142 and baffle 144 arrangement for a column settler 120 according to some non-limiting embodiments;

FIG. 8 shows a shaft 152 and baffle 154 arrangement for a column settler 120 according to some non-limiting embodiments;

FIG. 9 shows a shaft 162 and baffle 164 arrangement for a column settler 120 according to some non-limiting embodiments;

FIGS. 10-13 are schematic diagrams showing possible shaft and baffle movements and configurations within a column according various non-limiting embodiments; and,

FIGS. 14-16 show yet another non-limiting example of a baffle 624 which may be practiced with certain embodiments.

FIG. 17 shows yet another non-limiting example of a mixer-settler system 100 according to some embodiments, wherein a column settler 120 may comprise flared, fluted, or tapered walls, or may otherwise comprise an “hourglass” shape, without limitation.

FIG. 18 shows yet another non-limiting example of a mixer-settler system 100 according to some embodiments, wherein a column settler 120 may comprise flared, fluted, or tapered walls, or may otherwise comprise an “center bulged” shape, without limitation.

FIG. 19 shows a mixer-settler system 100 according to some embodiments; wherein a spiral downcomber or centrifugal coalescer 810 may be utilized to pre-treat an emulsion phase entering a column settler 120, without limitation.

FIG. 20 shows a mixer-settler system 100 according to some embodiments; wherein a spiral downcomber or centrifugal coalescer 810 may be utilized to pre-treat an emulsion phase entering a column settler 120; and wherein a pre-conditioner 710 may be used to remove entrained air before an emulsion phase enters the downcomber or centrifugal coalescer 810, without limitation.

FIG. 21 suggests different manners in which a column settler 120 may be “functionally graded”, for example, wherein a column settler may be provided with one or more features as a function of coalescence rate and/or droplet size distributions, without limitation.

FIG. 22 suggests potential manners in which a column settler 120 may be functionally graded, for example, to address asymmetrical collections of organic phase droplets on walls of a column settler 120; wherein one or more types of baffles may be provided; and wherein the one or more baffles may have varying axial thickness, varying number, and/or permeability/porosities, without limitation.

FIG. 23 suggests a skid-mounted mixer-settler system 100 according to some embodiments; which may be utilized in a pilot test environment, without limitation; wherein an optional mixer 110 may comprise a redundant mixer which may serve to maintain an unstable emulsion phase received from a larger upstream mixer (not shown), without limitation.

FIG. 24 suggests one non-limiting embodiment of a motor 129 and respective transmission/gearbox 127 which may be utilized according to some embodiments, wherein in the particular embodiment shown, a crank mechanism (or cam and yoke system) may be provided for reciprocating movement of a column shaft 122, and wherein the crank mechanism (or cam and yoke system not shown) may be infinitely adjustable (e.g., via screw thread or link turnbuckle), and/or finitely adjustable (e.g., via a number of provided threaded holes provided to a crank wheel).

### DETAILED DESCRIPTION OF THE INVENTION

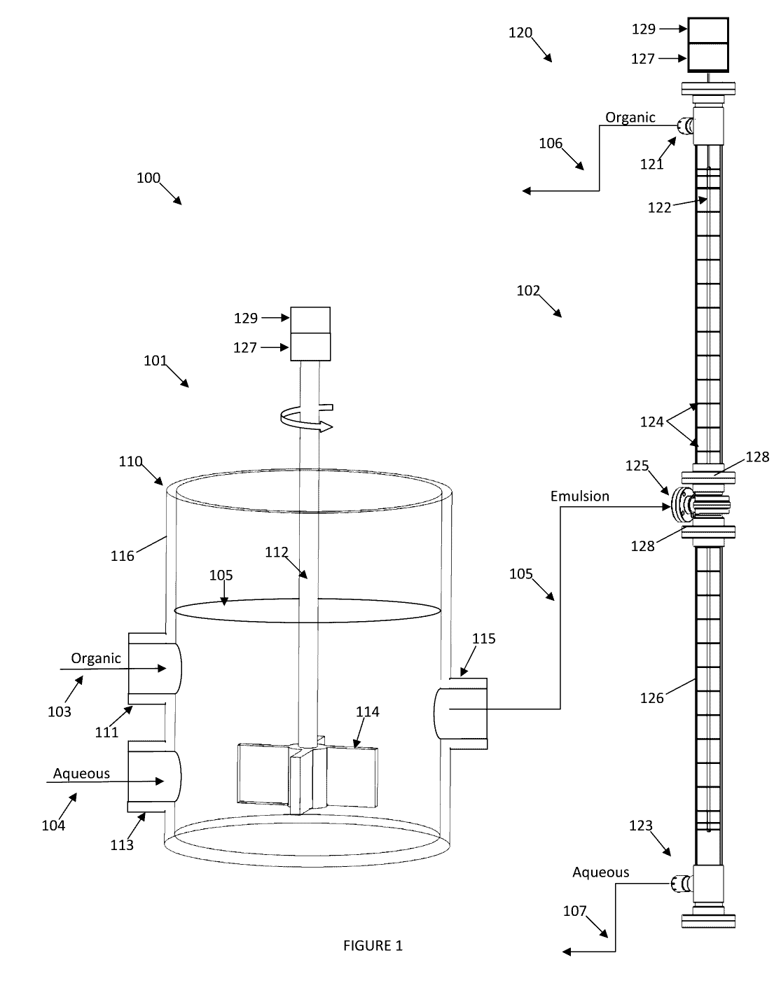

Turning now to FIGS. 1-5, a mixer-settler system 100 is provided, the system having a mass transfer step 101 and a gravity settling step 102. The mass transfer step 101 comprises receiving a first organic phase 103 and receiving a first aqueous phase 104 into a mixer 110. The mixer 110 has an organic inlet 111 and an aqueous inlet 113 for receiving the respective first organic phase 103 and first aqueous phase 104 into the mixer 110. The first organic phase 103 and first aqueous phase 104 may, via high energy inputs, be mixed into a mixed unstable emulsion phase 105 via a rotating mixing shaft 112 and impeller 114 provided to the mixer 110. The mixing shaft 112 is rotated via a motor 129 and an optional transmission, gearbox, or variable frequency drive (VFD) 127. Preferably, the RPM of the mixing shaft 112 and the impeller 114 design is configured for mixing the first organic phase 103 with the first aqueous phase 104, and/or maintaining a mixed unstable emulsion phase 105. The mixer 110 may further comprise a mixer tank 116 configured to hold or otherwise maintain the mixed unstable emulsion phase 105 in suspension for a predetermined residence time, at which liquid-liquid contact is optimized for mass transfer between the first organic 103 and first aqueous 104 phases.

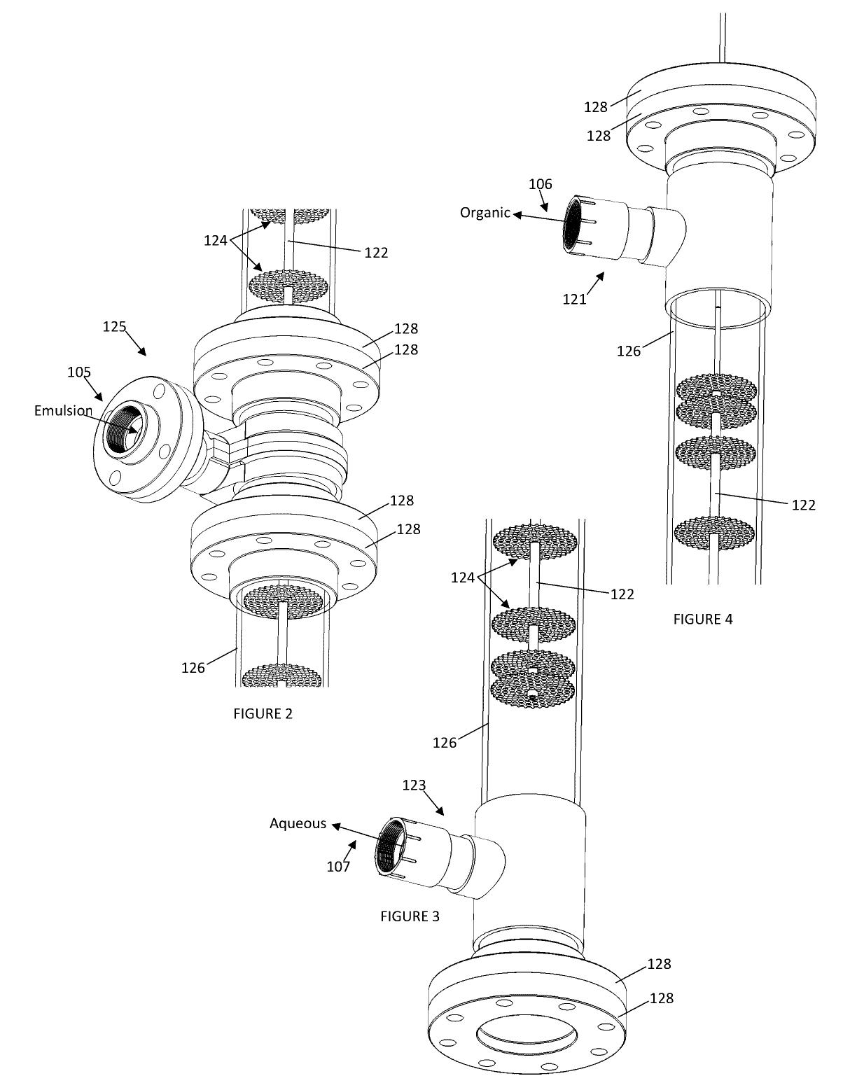

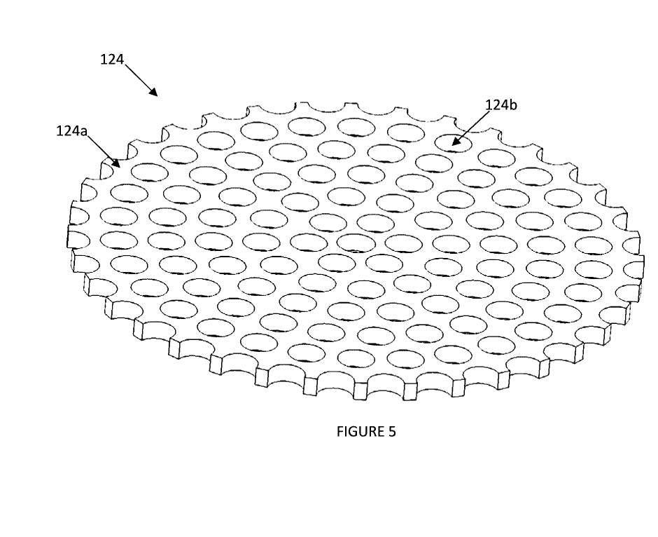

The mixer 110 further comprises an emulsion outlet 115, for sending the unstable emulsion phase 105 to a column settler 120 associated with the gravity settling step 102. The unstable emulsion phase 105 enters the column settler 120, e.g., via an emulsion inlet 125, which may be provided to a central region of the column settler 120 as shown. The emulsion inlet 125 may be a T-fitting, which is preferably provided in a volute configuration as shown. The volute configuration preferably spirals in a clockwise or counter-clockwise direction. In some embodiments, the volute configuration of the emulsion inlet 125 spirals in the same direction as the mixing shaft 112 turns (if applicable), so that energy associated with the influent mixed unstable emulsion phase 105 may dissipate within the column gradually. The column settler 120 may comprise an elongated, vertically-extending column tank 126 having minimal footprint. The column settler 120 may further comprise a motor 129 and associated transmission, gearbox, or VFD 127, wherein the motor 129 turns and/or displaces a gentle agitation shaft 122 within the column settler 120. The turns and/or displacements may be caused by a motor armature turning, and/or the displacements may be caused by one or more axial inputs, for instance, an extendable and/or retractable cylinder 470 or piston 471 operatively connected to the shaft 122. The shaft 122 within the column settler 120 may comprise one or more baffles 124, without limitation, as shown. In some embodiments, the baffles 124 may comprise one or more open portions 124b within a solid portion 124a. The one or more open portions 124b may be in any number, size, orientation, shape, configuration, or combination, without limitation. The baffles 124 may be stationary and provided in any form or fashion within the column tank 126, and/or the baffles 124 may be provided to portions of the slowly moving gentle agitation shaft 122. The column settler 120 may further comprise an aqueous outlet 123 provided at the bottom of the column tank 126, which is configured to emit a second stabilized aqueous phase 107 from the column tank 126. The column settler 120 may further comprise an organic outlet 121 provided at the top of the column tank 126, which is configured to emit a second stabilized organic phase 106 from the column tank 126. Due to its elongated nature and large vertical stature, one or more flanges 128 or other tube or piping adapters may be used to connect various components of the column settler 120 together, or otherwise assemble or disassemble the column settler 120. For example, the flanges 128 may be adapted to receive a sleeve, section, or wall portion of a column tank 126; or, as shown in FIG. 2, the flanges 128 may be adapted to capture a T-fitting or other junction device. As shown in FIG. 3, flanges 128 may sealed off and bolted to a floor. As shown in FIG. 4, flanges 128 may be used to bolt the column settler 120 to a motor 129, transmission 127, ceiling, or other structural column support member.

Turning to FIG. 5, each baffle 124 may be configured with means for an unstable emulsion phase 105 to come into contact with, and/or pass through open portions 124b. The open portions 124b may be evenly distributed as shown, or they may comprise different patterns, shapes, arrangements, combinations, and/or variations in size, without limitation. Preferably, a baffle 124 design will provide the best coalescing rates for a particular incoming unstable emulsion phase 105. The baffles may be stagnant or configured to move, e.g., by virtue of being provided to a reciprocating, vibrating, rotating, moving, and/or otherwise agitated shaft 122. The rate (e.g., frequency of oscillations, revolutions per minute) at which the baffle and/or shaft 122 moves is less than what would be necessary to mix a first organic phase 103 and a first aqueous phase 104 as does the mixer 110. Preferably, the rate is positive, and just above zero, where maximum coalescence is obtained, gravity settling of the second stabilized organic phase 106 and second stabilized aqueous phase 107 out of the unstable emulsion phase 105 is accelerated, and substantially no further mixing or additional mass transfer occurs within the column settler 120.

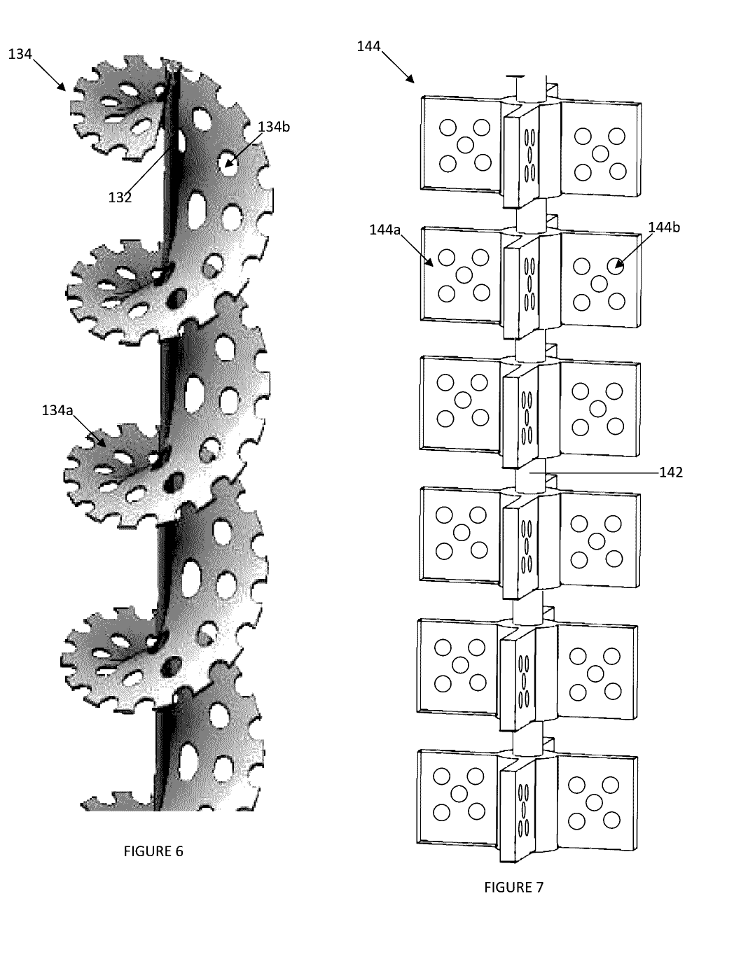

Turning now to FIG. 6, a column settler discussed herein may comprise a helical baffle 134 or number of helical baffles 134 or baffle portions. The helical baffle 134 may be provided to a wall portion of the column tank 126, and/or to a gentle agitation shaft 132 as shown. The baffle 134 may comprise a solid portion 134a and one or more open portions 134b provided to the solid portion 134a. The helical baffle 134 may slowly rotate in a clockwise or counter-clockwise direction. While not shown, the helical baffle 134 may reverse in direction halfway along or a part of the way along the shaft 132. In this regard, a helix direction may be different for areas of the column 126 which are configured to hold a different phases 106, 107. Alternatively, portions of the shaft 122 may have one or more other types or portions of non-helical baffles such as the baffles 124 shown in FIGS. 1-5.

Turning now to FIG. 7, a column settler discussed herein may comprise one or more paddles or radial baffles 144. The baffles 144 may be provided to a wall of the column tank 126, and/or to a gentle agitation shaft 142 as shown. The baffles 144 may comprise a solid portion 144a and one or more open portions 144b provided to the solid portion 144a. The radial baffles 144 may slowly rotate in a clockwise or counter-clockwise direction to gently push or tug at an unstable emulsion phase 105, a stabilized organic phase 106, and/or a second stabilized aqueous phase 107, without causing mixing, and while facilitating coalescence. Moreover, the radial baffles 144 may slice vertically through one or more phases 105, 106, 107, if the shaft 142 reciprocates along an axis of shaft 142. The reciprocation motion may comprise a small amplitude, or a large amplitude. The reciprocation motion may also comprise a high frequency or a low frequency. In some preferred embodiments, reciprocation motions having a higher frequency will have a lower amplitude (i.e., stroke). In any event, energy imparted through motion to the phases 105, 106, 107, is minimal so as to not promote mixing or continued suspension of the two second stabilized phases 106, 107. In other preferred embodiments, reciprocation motions having a lower frequency will have a higher amplitude (i.e., stroke). While not shown, the vertically-arranged radially-extending baffles 144 may further comprise horizontally-arranged, spirally-extending baffles, swept baffles, pitched baffles, or the like in any configuration without limitation. In some regards, baffle 144 directions, sizes, orientations, patterns, and/or configurations may be different for certain areas of the column settler 120 than for other areas. For example, sections of a column tank 126 which are configured to hold a second stabilized organic phase 106 may comprise certain baffle 144 arrangements and/or features, and sections of a column tank 126 which are configured to hold a second stabilized aqueous phase 107 may comprise different baffle arrangements and/or features than said certain baffle 144 arrangements. Alternatively, sections of a column tank 126 which are configured to receive an incoming unstable emulsion phase 105 may comprise baffles or no baffles, or baffle arrangements which are different than other sections of the column settler 120.

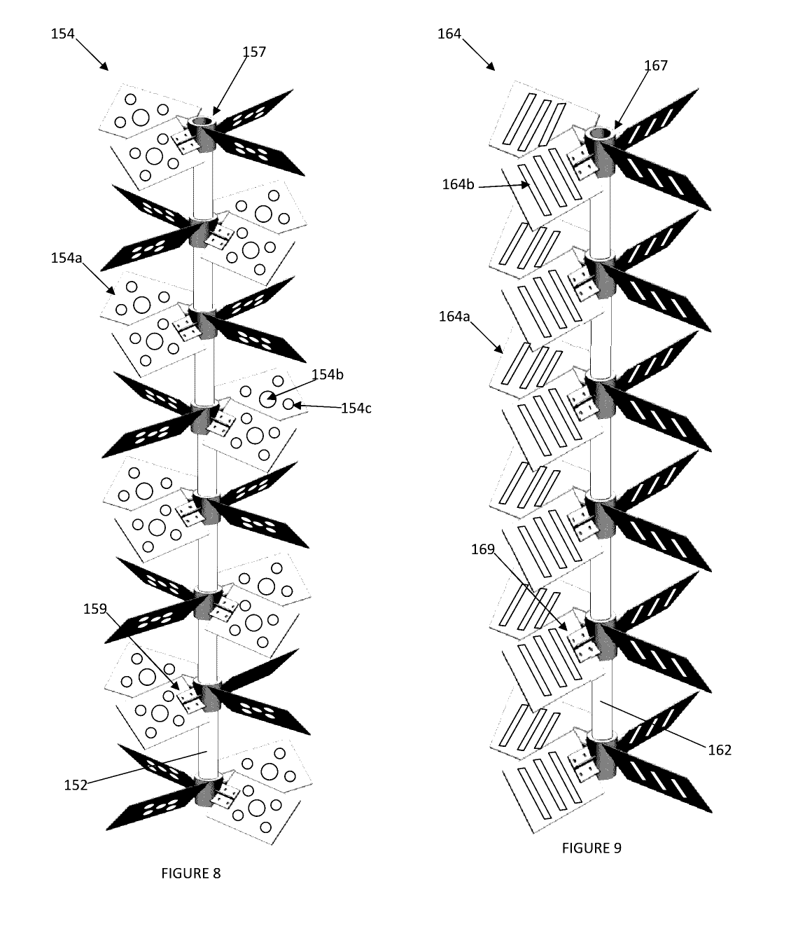

Turning now to FIG. 8, a column settler discussed herein may comprise one or more paddles or pitched blade baffles 154. The baffles 154 may be provided to a wall of the column tank 126, and/or to a gentle agitation shaft 152 as shown. Each of the baffles 154 may comprise a solid portion 154a and one or more open portions 154b provided to the solid portion 154a. The one or more open portions 154b may comprise one or more second different open portion 154c which are, for instance, smaller or larger in size, or of a different shape or orientation.

The baffles 154 may be attached to the gentle agitation shaft 152 via a hub 157 and one or more mounts 159 positioned between the hub 157 and baffles 154. The pitched baffles 154 may slowly rotate in a clockwise or counter-clockwise direction to gently push or tug at an unstable emulsion phase 105, a stabilized organic phase 106, and/or a second stabilized aqueous phase 107, without causing mixing, and while facilitating coalescence. As shown, the pitch of baffles may change along an axis of the gentle agitation shaft 152. Pitches of baffles 154 may alternate as shown, or gradually increase, or may be randomized. Moreover, some of the pitched baffles 154 may slice through one or more phases 105, 106, 107, differently as the shaft 152 reciprocates along an axis of shaft 152 and/or rotates clockwise or counter-clockwise within the column settler 120. Reciprocation motion may comprise small or large amplitudes, and/or high or low frequencies. Revolving motion may comprise very low to moderate RPMs. In some preferred embodiments, reciprocation motions having a higher frequency will have a lower amplitude (i.e., stroke). In any event, energy imparted through motion to the phases 105, 106, 107, is minimal so as to not promote mixing or continued suspension of the two second stabilized phases 106, 107. In other preferred embodiments, reciprocation motions having a lower frequency will have a higher amplitude (i.e., stroke). While not shown, the vertically-arranged radially-extending baffles 154 may further comprise horizontally-arranged, spirally-extending baffles, swept baffles, vertically or horizontally-oriented baffles, curved baffles, or the like in any configuration without limitation. In some regards, baffle 154 directions, sizes, orientations, patterns, and/or configurations may be different for certain areas of the column settler 120 than others. For example, sections of a column tank 126 which are configured to hold a second stabilized organic phase 106 may comprise certain baffle 154 arrangements and/or features, and sections of a column tank which are configured to hold a second stabilized aqueous phase 107 may comprise different baffle arrangements and/or features. Alternatively, sections of a column tank 126 which are configured to receive an incoming unstable emulsion phase 105 may comprise baffles or no baffles, or baffle arrangements which are different than other sections of the column settler 120.

Turning now to FIG. 9, a column settler discussed herein may comprise one or more paddles or pitched blade baffles 164. The baffles 164 may be provided to a wall of the column tank 126, and/or to a gentle agitation shaft 162 as shown. Each of the baffles 164 may comprise a solid portion 164a and one or more open portions 164b provided to the solid portion 164a. The one or more open portions 164b shown comprise elongated slits or slots, but may comprise one or more second different open portions (not shown) which are, for instance, smaller or larger in size, or of a different shape or orientation.

The baffles 154 may be attached to the gentle agitation shaft 162 via a hub 167 and one or more mounts 169 positioned between the hub 167 and baffles 164. The pitched baffles 164 may slowly rotate in a clockwise or counter-clockwise direction to gently push or tug at an unstable emulsion phase 105, a stabilized organic phase 106, and/or a second stabilized aqueous phase 107, without causing mixing, without promoting mass transfer, and while facilitating coalescence and separation of the organic 106 and aqueous 107 phases. As shown, the pitch of baffles 164 may stay the same along an axis of the gentle agitation shaft 162. Pitches of baffles 164 may alternate as shown in FIG. 8, not alternate as shown in FIG. 9, or gradually increase, or may be randomized. Moreover, some of the pitched baffles 164 may slice through one or more phases 105, 106, 107 differently as the shaft 162 reciprocates along an axis of shaft 162 and/or rotates clockwise or counter-clockwise within the column settler 120. Furthermore, baffles 164 may be provided to shaft 162 with different spacing or similar spacing therebetween. Reciprocation motion may comprise small or large amplitudes, and/or high or low frequencies. Revolving motion may comprise very low to moderate RPMs. In some preferred embodiments, reciprocation motions having a higher frequency may have a lower amplitude (i.e., stroke). In other preferred embodiments, reciprocation motions having a lower frequency may have a higher amplitude (i.e., stroke). While not shown, the vertically-arranged radially-extending baffles 164 may further comprise horizontally-arranged, spirally-extending baffles, swept baffles, vertically or horizontally-oriented baffles, curved baffles, or the like in any configuration without limitation. In some regards, baffles 164 directions, sizes, orientations, patterns, and configurations may be different for certain areas of the column settler 120 than for others. For example, sections of a column tank 126 which are configured to hold a second stabilized organic phase 106 may comprise certain baffle 164 arrangements and/or features, and sections of a column tank 126 which are configured to hold a second stabilized aqueous phase 107 may comprise different baffle arrangements and/or features. Alternatively, sections of a column tank 126 which are configured to receive an incoming unstable emulsion phase 105 may comprise baffles or no baffles, or baffle arrangements which are different than other sections of the column settler 120.

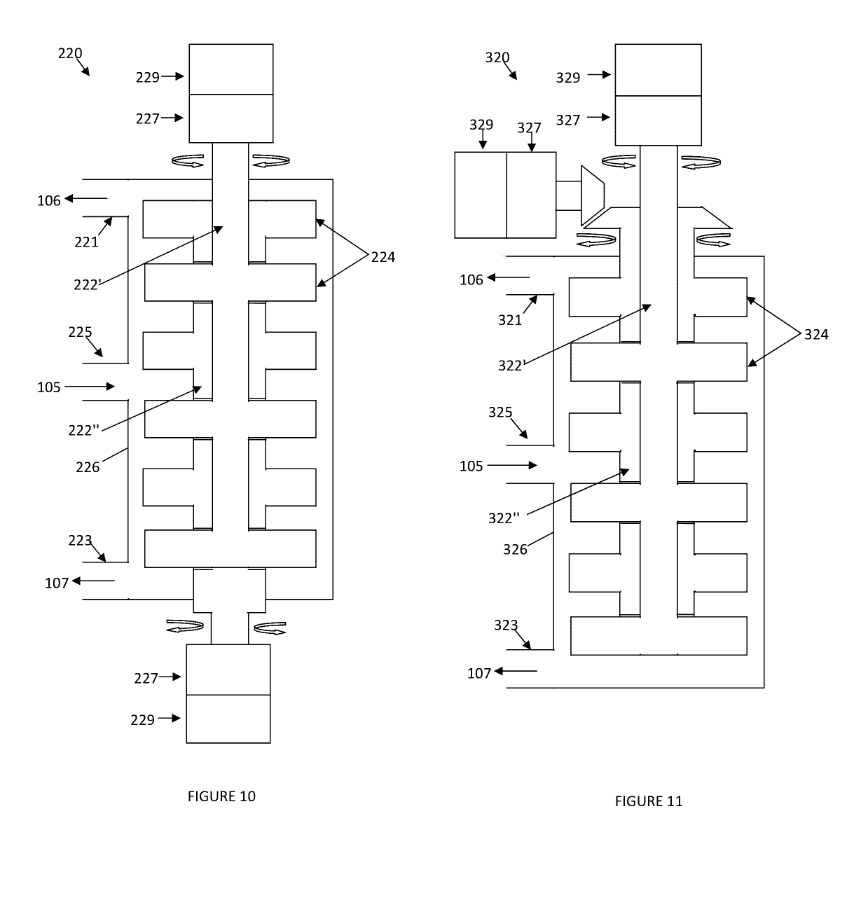

Turning now, to FIGS. 10-13, various embodiments of a column settler 220, 320, 420, 520 are shown. In FIG. 10, a column settler 220 may comprise an organic outlet 221, an aqueous outlet 223, and an emulsion inlet 225 for receiving an unstable emulsion phase 105. The column settler 220 may also comprise a column tank 226 within which an inner gentle agitation shaft 222′ and an outer gentle agitation shaft 222″ move. The movement of the inner 222′ and outer 222″ gentle agitation shafts may comprise reciprocation, rotation, rotation reversal agitation as shown, or various combinations thereof in any sequence. In other words, in some preferred embodiments, a first transmission, gearbox, or VFD 227 associated with a first motor 229 may rotate an inner gentle agitation shaft 222′ clockwise, and a second transmission, gearbox, or VFD 227 associated with a second motor 229 may rotate an outer gentle agitation shaft 222″ counter-clockwise. One or more baffles 224 may be provided to the inner 222′ and outer 222″ gentle agitation shafts as shown, and/or one or more baffles 224 may be provided to various wall portions of the column tank 226.

As shown in FIG. 11, a column settler 320 may comprises an organic outlet 321, an aqueous outlet 323, and an emulsion inlet 325 for receiving an unstable emulsion phase 105. The column settler 320 may also comprise a column tank 326 within which an inner gentle agitation shaft 322′ and an outer gentle agitation shaft 322″ move. The outer gentle agitation shaft 322″ may comprise small openings (not shown) for one or more baffles 324 provided to the inner gentle agitation shaft 322′ to pass with clearance. In such an embodiment, the inner 322′ and outer 322″ shafts may move independent of each other in the same direction or opposite directions of rotation. Movement between the inner 322′ and outer 322″ shafts may be limited by the size of openings within the outer 322″ shaft which make clearance for the baffles 324 associated with the inner 322′ shaft.

The movement of the inner 322′ and outer 322″ gentle agitation shafts may comprise reciprocation, rotation, or rotation reversal agitation as shown. In other words, a first transmission, gearbox, or VFD 327 associated with a first motor 329 may rotate an inner gentle agitation shaft 322′ an angular distance clockwise, and a second transmission, gearbox, or VFD 327 associated with a second motor 329 may rotate an outer gentle agitation shaft 322″ an angular distance counter-clockwise, before stopping and reversing rotations. One or more baffles 324 may be provided to the inner 322′ and outer 322″ gentle agitation shafts as shown, and/or one or more baffles 324 may be provided to various wall portions of the column tank 326 (not shown). In the instant case shown, the second motor 329 and the first motor 329 may be provided to the same side of a column settler 320, wherein a second transmission, gearbox, or VFD 327 is not axially-aligned with the outer 322″ gentle agitation shaft. For example, the second transmission, gearbox, or VFD 327 may comprise a spur gear and be axially aligned parallel with an axis of the outer 322″ gentle agitation shaft (not shown). Or, the outer 322″ gentle agitation shaft may comprise a mitered, beveled, or worm ring gear and be positioned outside of axial alignment with the second transmission, gearbox, or VFD 327 as shown in FIG. 11.

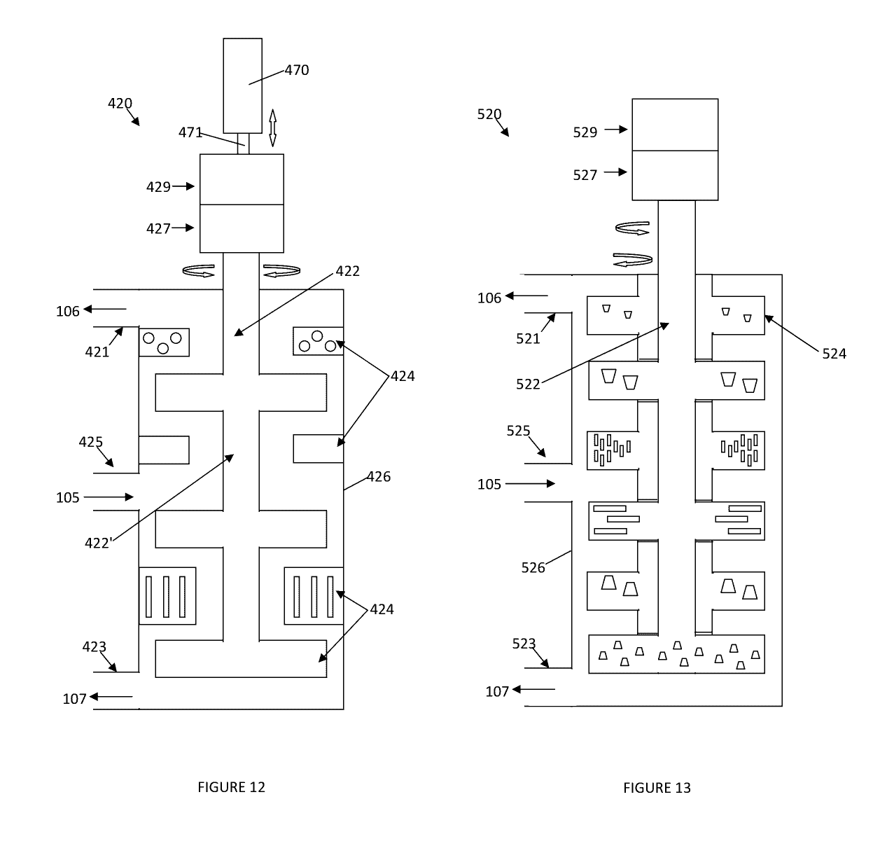

As shown in FIG. 12, a column settler 420 may comprise an organic outlet 421, an aqueous outlet 423, and an emulsion inlet 425 for receiving an unstable emulsion phase 105. The column settler 420 may also comprise a column tank 426 within which a gentle agitation shaft 422 may move. The shaft 422 may comprise one or more baffles 424 provided to the gentle agitation shaft 422 to pass with clearance. In such an embodiment, the shaft 422 may move in any direction, for example, an up or down direction, and/or in a clockwise or counter-clockwise direction. Movement between the shaft 422 and portions of the column tank 426, including baffles 424, which may be provided to walls of the column tank 426, may be limited to reduce energy, reduce the potential for mixing and/or mass transfer within the column settler 420, to promote coalescence, and speed up coalescence.

The movement of the gentle agitation shaft 422 may comprise reciprocation, rotation, or rotation reversal agitation as shown. In other words, a transmission, gearbox, or VFD 427 associated with a motor 429 may rotate the gentle agitation shaft 422 clockwise or counter clockwise. A cylinder 470 having a piston rod 471 operatively coupled to the motor 429 may comprise a rod 471 having a motor 429 secured thereto. In this regard, displacement of the cylinder rod 471 may be configured to move the shaft 422 in and out of (i.e., up and down) the column 426—including directions extending along the shaft 422 axis. One or more baffles 424 may be provided to the gentle agitation shaft 422 as shown, and/or one or more baffles 424 may be provided to various wall portions of the column tank 426 (not shown). In the instant case shown, one or more open portions associated with the baffles 424 may differ depending on baffle 424 locations within the column 420. In some preferred embodiments, no motor 429, and no transmission, gearbox, or VFD 427 associated with said motor 429 may be provided, wherein the gentle agitation shaft 422 is purely connected to the piston rod 471 of cylinder 470, and wherein the gentle agitation shaft 422 moves slowly up and down within the column so as to speed coalescence, but not mix the separating phases 106, 107. Cylinder 470 may be of the pneumatic or hydraulic type, without limitation.

In other preferred embodiments, no cylinder 470 may be provided, and a transmission, gearbox, or VFD 427 associated with a motor 429 may be adapted to convert rotational motion into reciprocating motion. Such mechanisms may include, for example, a four stop reciprocating mechanism, a Scotch yoke, a Scotch yoke mechanism with dwell at both ends, a Scotch yoke mechanism with dwell at one end, a rack and pinion mechanism, a linkage (e.g., a four-bar linkage), a rotary to linear mechanism, a rack and pinion reciprocate mechanism, a cam mechanism (e.g., with or without pause), and a one rotation two-stroke mechanism, without limitation. In other words, the gentle agitation shaft 422 may be operatively connected with a shaft of a motor 429, wherein a transmission, gearbox, or VFD 427 converts rotary motion of the motor's 429 shaft to a reciprocating motion applied to the gentle agitation shaft 422. The gentle agitation shaft 422 may move slowly up and down within the column 426 so as to speed up coalescence, but not mix the separating phases 106, 107.

As shown in FIG. 13, a column settler 520 associated with a gravity settling step 102 may comprise an organic outlet 521, aqueous outlet 523, and emulsion inlet 525. A motor 529 operatively coupled with a transmission, gearbox, or VFD 527 may control movement of a gentle agitation shaft 522. As shown, the gentle agitation shaft 522 may comprise a movable shaft within a stationary baffle 524 which is secured to the column tank 526 and which may generally be immovable relative to the column tank 526. The gentle agitation shaft 522 may comprises one or more baffles 524 which are movable with respect to the column tank 526. In some preferred embodiments, the movable gentle agitation shaft 522 may comprise a first type of baffle 524 and the stationary baffle 524 may comprise a second different type of baffle, without limitation. As shown, a plurality of baffles 524 may be provided.

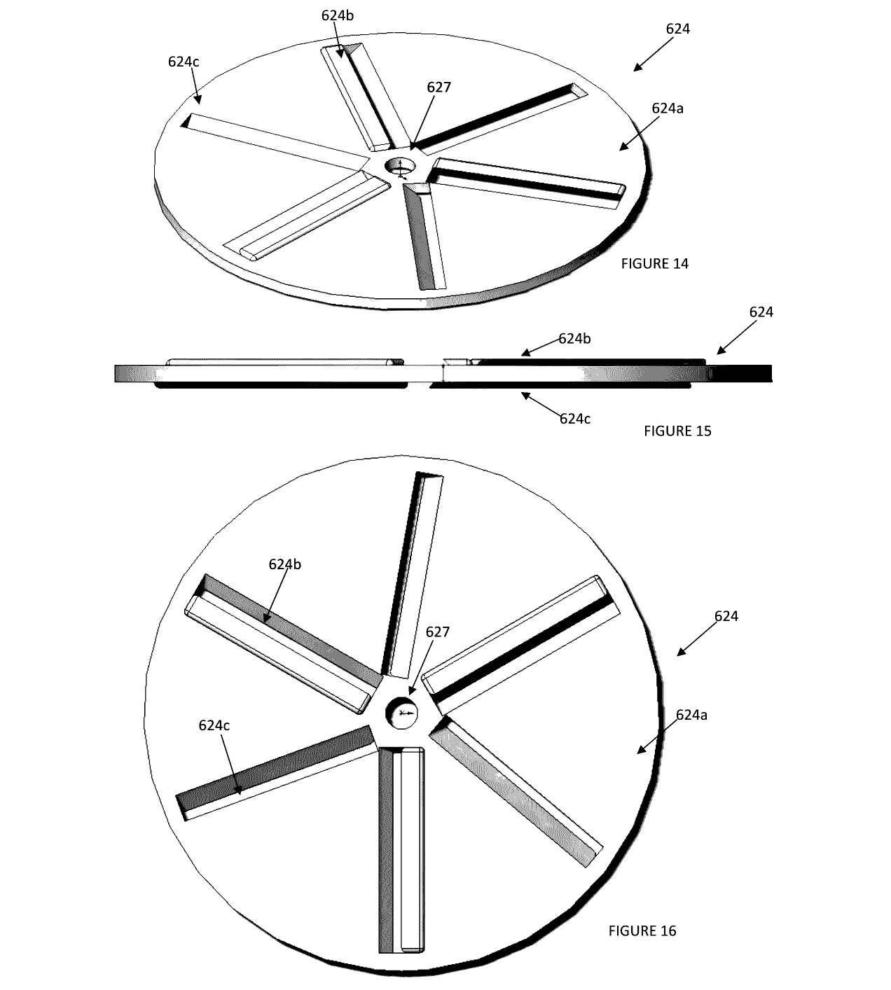

FIGS. 14-16 show a baffle 624 which may be provided to a gentle agitation shaft according to certain embodiments. The baffle 624 may be particularly useful for single direction rotational movements within a column settler 120; however, it is envisaged that the baffle 624 may be equally utilized with reciprocating movements and/or reversing-rotational movements within a column settler 120. The baffle 624 comprises a solid portion 624a surrounding a hub 667, one or more first open portions 624b, and one or more second different open portions 624c. The one or more first open portions 624b may, as shown, comprise upwardly-angled lips which scoop down denser aqueous phase droplets settling on upper surface portions of the baffle 624. The one or more second different open portions 624c may comprise downwardly-angled lips which scoop up lighter organic phase droplets rising to lower surface portions of the baffle 624. In other words, accumulated organic under the baffle 624 may be forced upward toward organic outlet 121 via the one or more second open portions 624c, and aqueous accumulated on top of the baffle may be forced or otherwise allowed to settle downward toward aqueous outlet 123 via the one or more first open portions 624. Preferably, as shown, the pitch of each of the first 624b and second 624c open portions is the same; however, the pitch may alternate between positive and negative, without limitation.

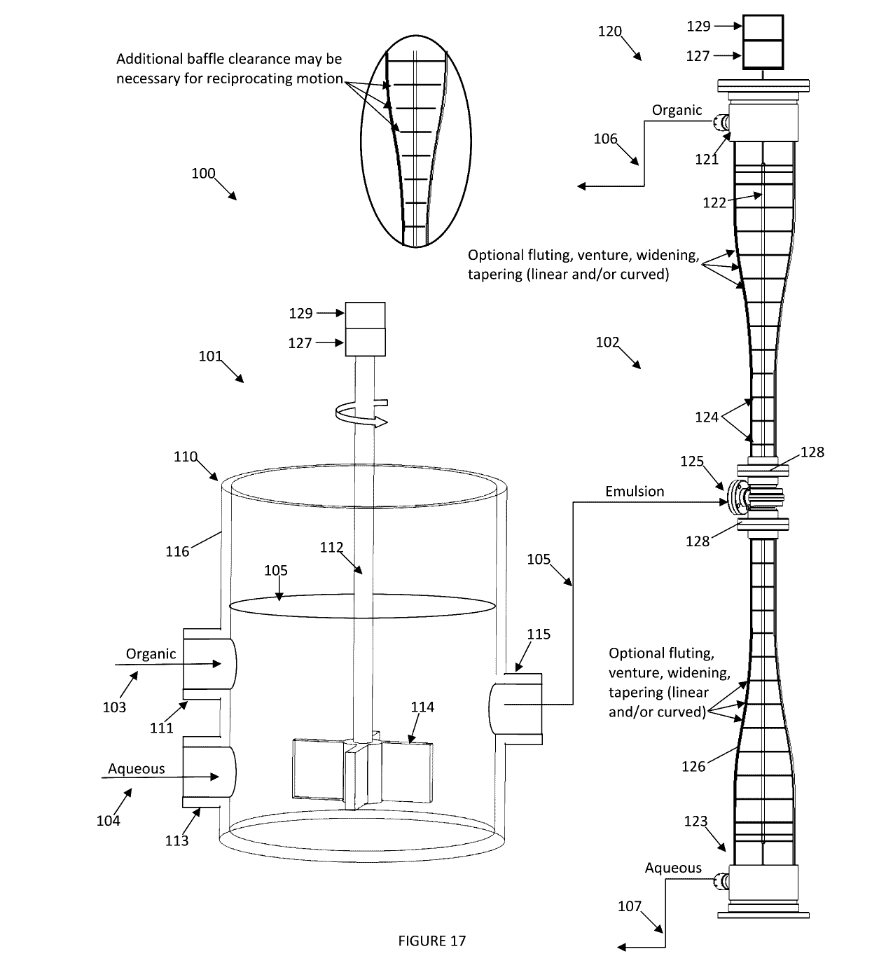

FIG. 17 shows yet another non-limiting example of a mixer-settler system 100 according to some embodiments, wherein a column settler 120 may comprise flared wall portions, fluted wall portions, and/or tapered wall portions, or may otherwise comprise an “hourglass” shape, without limitation. In some embodiments, a column settler 120 may comprise flared, fluted, and/or tapered ends. In some preferred embodiments, the column walls may widen or may otherwise expand in diameter as a distance from a centralized emulsion inlet 125 (e.g., volute entry) increases. In some embodiments, the transition between changes in column wall diameters may be abrupt (e.g., stepped or shelved, not shown) or smooth (as shown), for improved flow and/or minimized eddy currents. In this regard, a mixed unstable emulsion phase 105 entering the column settler 120 may initially flow with higher velocity, and may slow down prior to exiting the column settler 120 as substantially single-phase organic 106 and/or aqueous 107 solutions, without limitation. It is suspected that by slowing down solution as it flows upwards and/or downwards within the column 120, finer droplet size entrainments may have a longer residence time to coalesce and/or to reverse direction within the column settler 120. The varying shape of the column settler 120 walls may create a varying velocity profile of flow within the column settler 120, which may assist with mitigating entrainments in the organic 106 and/or aqueous 107 phases exiting the column settler 120, without limitation. It should be understood that in some instances, only a top portion of a column settler 120 may be fluted, for example, if most entrainments of aqueous occur within a substantially organic phase 106, without limitation.

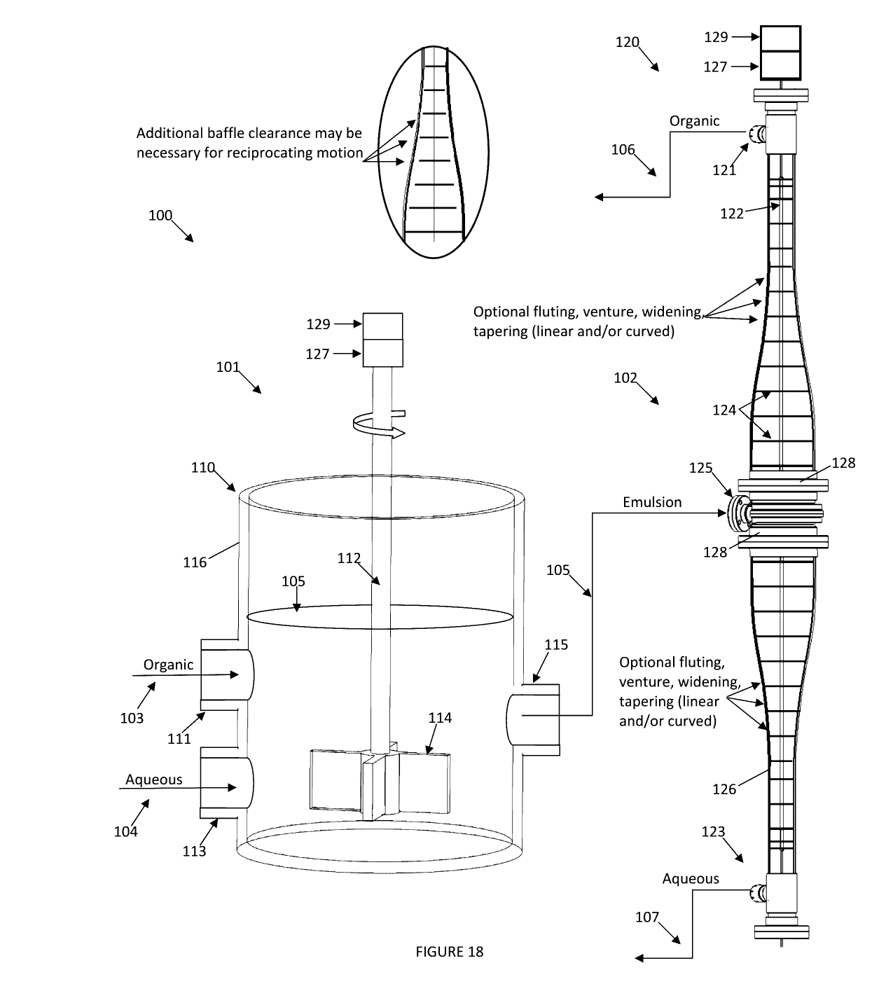

Regarding FIG. 18, the opposite may be true, wherein a column settler 120 may comprise flared wall portions, fluted wall portions, and/or tapered wall portions, or may otherwise comprise an “center bulged” shape, without limitation. In some embodiments, for instance, a column settler 120 may comprise a flared, fluted, and/or tapered center, wherein the column settler 120 may be wider at its center and narrower at its ends. The wider column settler inlet may provide for more residence time initially, without limitation.

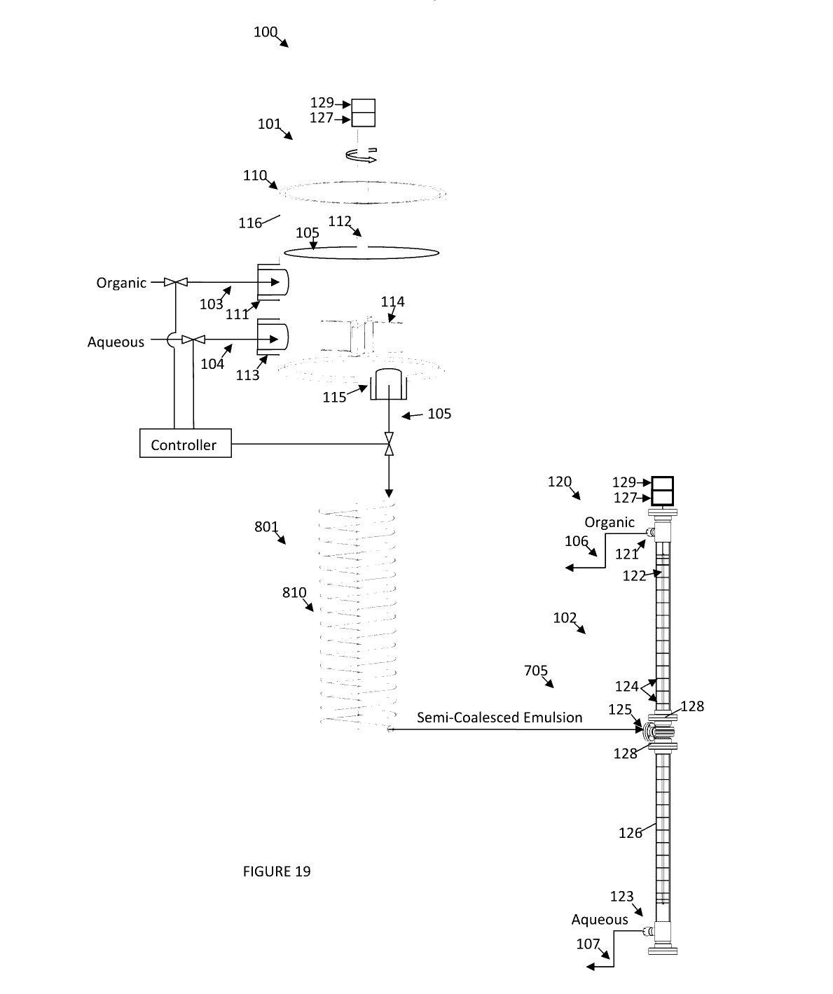

FIG. 19 shows a mixer-settler system 100 according to some embodiments; wherein a spiral downcomber or centrifugal coalescer 810 may be utilized to pre-treat an emulsion phase entering a column settler 120, without limitation. In some non-limiting embodiments, gravity (and/or a pump in some embodiments) may feed a mixed unstable emulsion phase 105 into an inlet of the spiral downcomber or centrifugal coalescer 810. As shown, a control valve may be employed and adjusted to ensure proper inflows of organic phase 103 and/or aqueous phase 104 to the mixer 110, for example, based upon flow rates of the mixed unstable emulsion phase 105 leaving the mixer 110. As the mixed unstable emulsion phase 105 traverses the spiral downcomber or centrifugal coalescer 810, coalescing may begin, and air may be released from solution. A semi-coalesced emulsion 705 exiting the spiral downcomber or centrifugal coalescer 810 may be subsequently fed into a column separator 120 in a manner consistent with those described and/or shown herein. In this regard, column 120 flow rates may be improved, and/or column 120 entrainments (including air entrainments) may be minimized, without limitation.

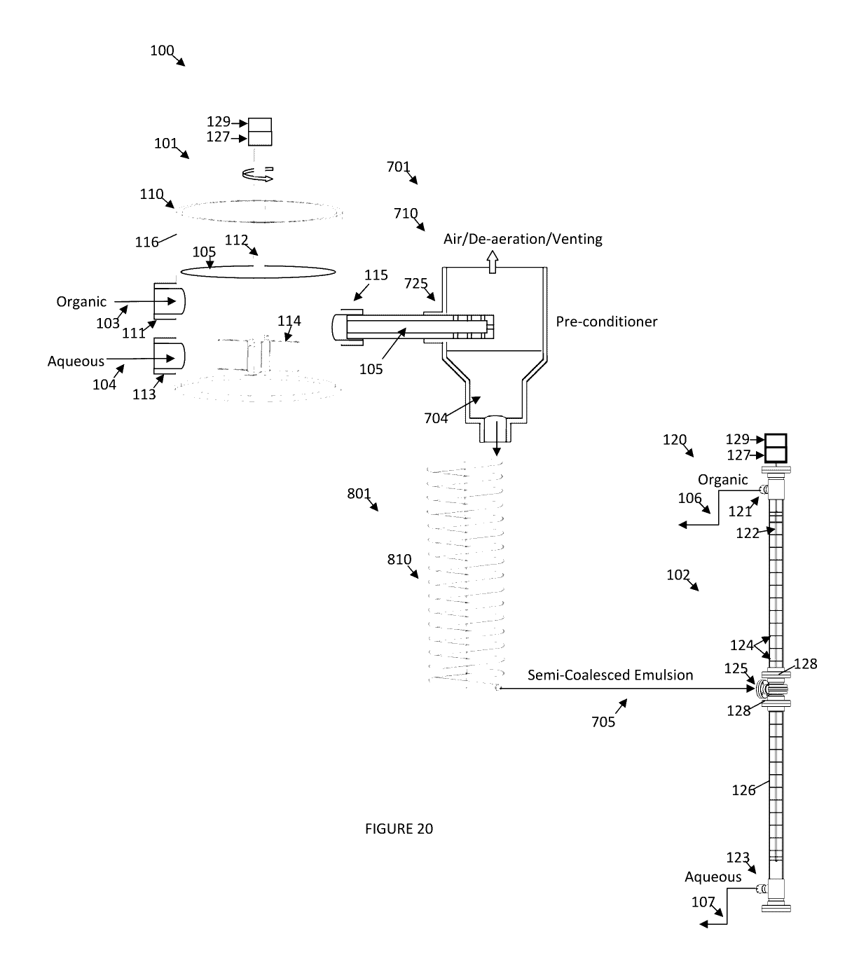

FIG. 20 shows a mixer-settler system 100 according to some embodiments; wherein a spiral downcomber or centrifugal coalescer 810 may be utilized to pre-treat an emulsion phase 705 entering a column settler 120; wherein a pre-conditioner 710 may be used in a first step to remove entrained air, without limitation. In other words, mixed unstable emulsion phase 105 may exit a mixer 110 under the power of gravity (and/or via one or more pumps, not shown), and may enter a pre-conditioner, such as a tank having an involute inlet 725, without limitation. The pre-conditioner 710 may serve to de-aerate and/or decant incoming mixed unstable emulsion phase 105, without limitation. A de-aerated mixed unstable emulsion phase 704 may leave the pre-conditioner 710 (preferably by gravity, without limitation), and may feed a spiral downcomber or centrifugal coalescer 810 which may further de-aerate and/or coalesce droplets within the de-aerated mixed unstable emulsion phase 704. After leaving the spiral downcomber or centrifugal coalescer 810, a semi-coalesced emulsion phase 705 may enter a column separator 120 as described herein, without limitation. In this regard, column 120 flow rates may be improved, and/or column 120 entrainments (including air entrainments) may be minimized, without limitation. In some preferred embodiments, the pre-conditioner 710 may comprise a cyclonic head tank with an involute feed pipe, which may be configured to establish a swirling motion within the tank, for example, in the same direction as the spiral downcomber or centrifugal coalescer 810. The pre-conditioner 710 may, without limitation, serve to release air, and/or develop head pressure to feed the downcomber or centrifugal coalescer 810 and subsequent column 120.

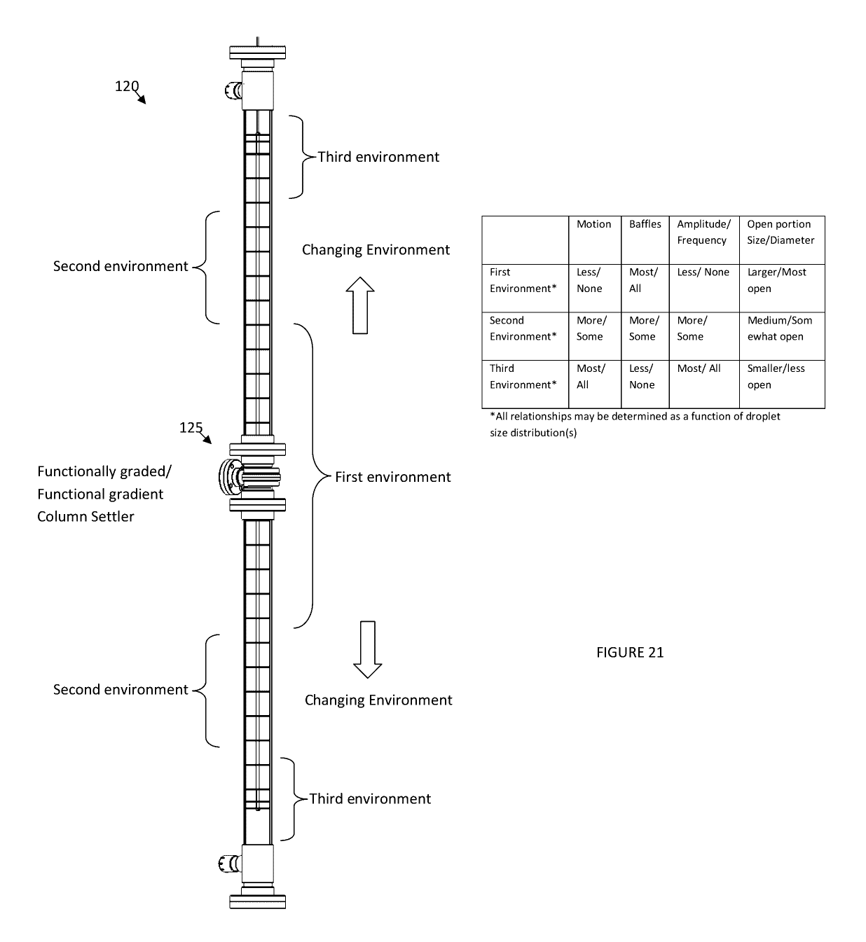

FIG. 21 suggests different manners in which a column settler 120 may be functionally graded, for example, as a function of coalescence rate and/or droplet size distributions, without limitation. In some embodiments, central portions of a column settler 120 which may be close or adjacent to an inlet 125 portion of the column settler 120, may comprise less motion, more baffles, less vibrations, smaller frequency gain(s), smaller baffles, and/or larger pore sizes of openings provided to baffles, without limitation. In some embodiments, end portions (e.g., upper and lower portions) of a column settler 120 which may be close or adjacent to organic and/or aqueous outlet portions of the column settler 120, may comprise more motion, a fewer number of baffles, more vibration, higher frequency gain(s), larger baffles, and/or smaller pore sizes of openings provided to baffles, without limitation. It should be understood that the opposite of the aforementioned may be true, without limitation. Various permutations and/or combinations of the shown and described variables are anticipated, without limitation.

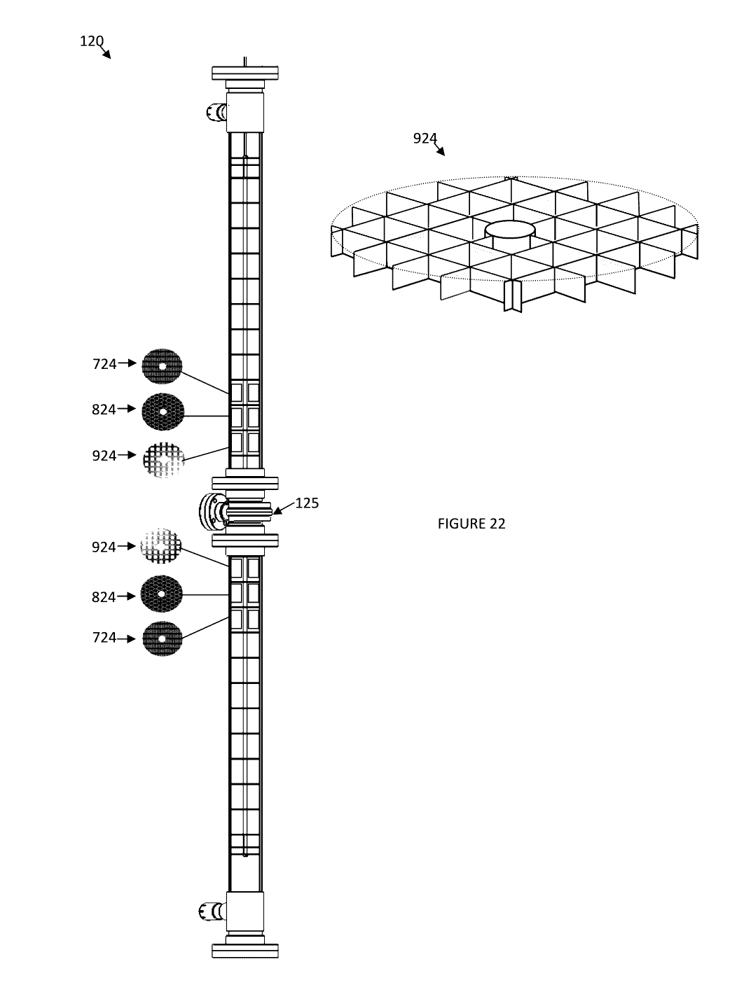

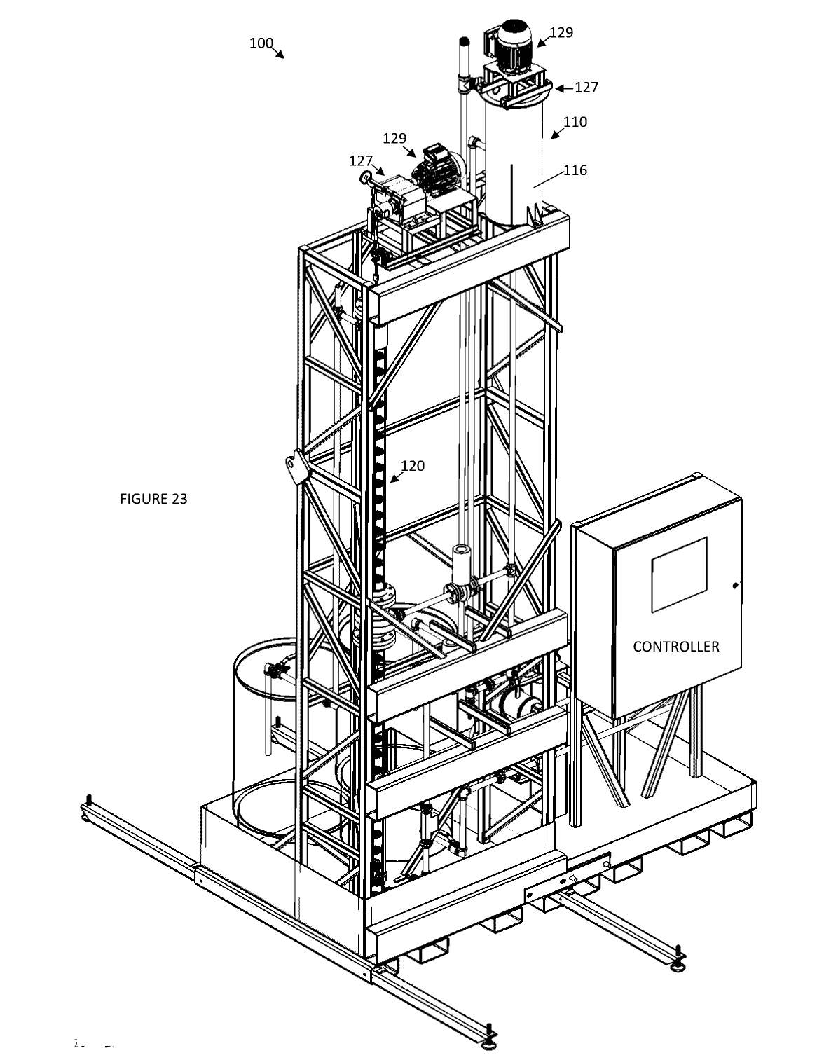

FIG. 22 suggests potential manners in which a column settler 120 may be functionally graded, for example, to address asymmetrical collection of organic phase droplets on walls of a column settler 120 adjacent central and/or end portions of a column settler 120. The asymmetrical gathering of droplets may be mitigated, for example, by providing one or more types of baffles 724, 824, 924 (which may have varying axial thickness, configurations, and/or permeability/porosities), in affected locations of the column settler 120, without limitation. The one or more baffles 724, 824, 924 may comprise elongated conduits, cannulated structures, and/or channels for solution to flow through. In some embodiments, as shown, they may comprise grate-like structures, without limitation. According to some non-limiting embodiments, spacings, patterns, and/or arrangements of the elongated conduits, cannulated structures, and/or channels may change depending upon a position of a respective baffle within a column settler 120, without limitation. According to some non-limiting embodiments, spacings between, respective patterns, and/or respective sizes and/or arrangements of one or more baffles 724, 824, 924 may change depending upon a position of a respective baffle within a column settler 120, without limitation. Three-dimensional patterns of baffles 724, 824, 924 may change, without limitation. In some embodiments, baffles 724, 824, 924 may resemble picket fences, crating, reticulated structures, porous structures, wire mesh, weaved/basketed material, or other type coalescing media known in the art. Groupings of similar or different baffles may be placed adjacent to portions of a column settler 120 and/or between other baffles within the column settler (e.g., moving baffles 124 provided to a shaft 122), without limitation. In this regard, flows may be regulated to prevent droplets from asymmetrically collecting at portions of the column settler 120. In some embodiments, some of the baffles 724, 824, 924 may be stationary, wherein other baffles 724, 824, 924 may comprise movements within the column. In some embodiments, baffles 724, 824, 924 may comprise grate-like structures with vertically-oriented/axially-oriented plate structures, without limitation. In some embodiments, baffles 724, 824, 924 may comprise grate-like structures with angled/non-axially-oriented plate structures, without limitation (not shown). In some embodiments (not shown), baffles 724, 824, 924 may comprise grate-like structures with various combinations of angled/non-axially-oriented plate structures and vertically-oriented/axially-oriented plate structures, without limitation.

It should be acknowledged that in some embodiments, portions of, some, and/or all of the baffles disclosed herein may be subjected to one or more vibrations or high frequencies with low amplitudes (e.g., ultrasound, without limitation). Such components may be damped from surrounding column settler components 120, without limitation. Energies may be introduced into solutions and phases 106, 107 thereof contained within a column settler, without limitation. The one or more vibrations or high frequencies may be concentrated in predetermined portions of a column settler 120 according to some embodiments, for example, vibrations or high frequencies may be concentrated at end or outlet portions, in order to encourage fine droplet movement/coalescence and perhaps reduce surface tension, without limitation. In some embodiments, vibrations or high frequencies may be concentrated at central portions, in order to encourage quick phase separations. The one or more vibrations or high frequencies may vary over time, or vary with respect to a distance from an emulsion inlet 125, without limitation. Moreover, in some embodiments, the one or more vibrations or high frequencies may be pulsed or otherwise intermittently employed, without limitation. In some embodiments, the one or more vibrations or high frequencies may be continuously employed, without limitation. In some embodiments, the one or more vibrations or high frequencies may be attenuated and/or increased as a function of time, without limitation. In some embodiments, the one or more vibrations or high frequencies may preferably be selected so as to avoid natural resonant frequencies of column components. In some embodiments, a first vibration or high frequency may be used in a first portion of the column settler, and a second vibration or high frequency may be used in a second portion of the column settler, without limitation. In yet further embodiments, a third vibration or high frequency may be used in a third portion of the column settler, and a fourth vibration or high frequency may be used in a fourth portion of the column settler, without limitation.

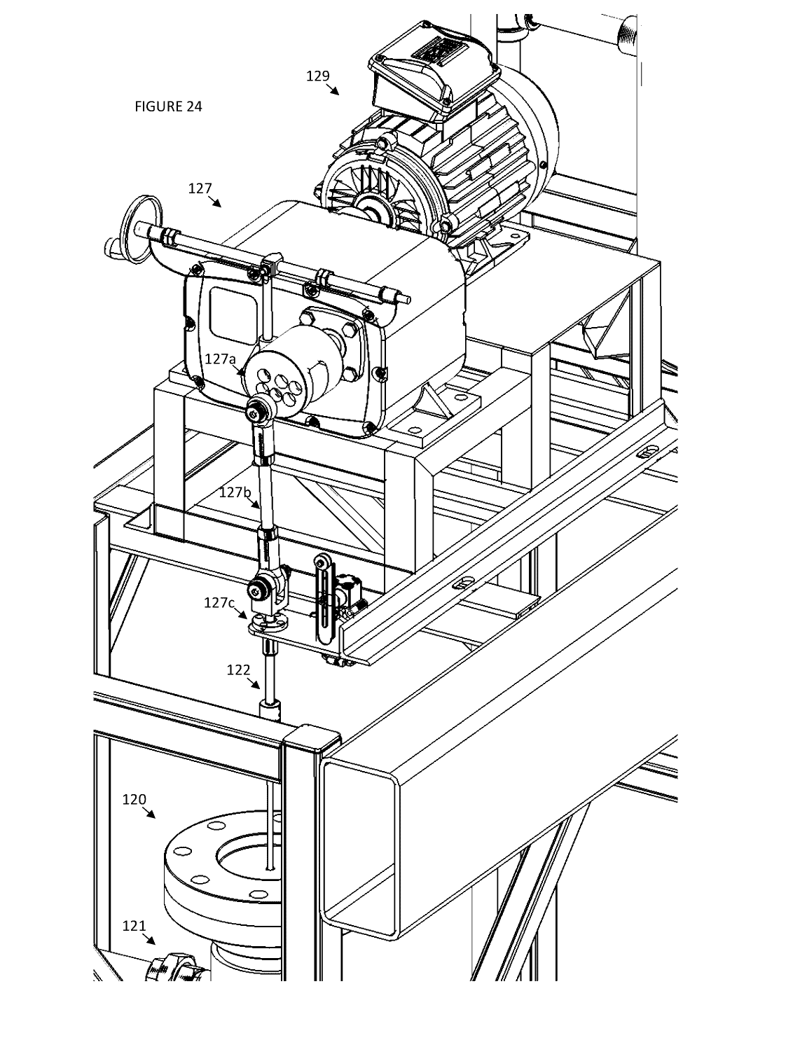

As shown in FIG. 24, an adjustable drive 127 may comprise a spindle input from a drive motor 129. An output of the adjustable drive 127 may comprise a rotating cam 127a which may be operably engaged with a link 127b, as shown. The link 127b may be adjustably connected to the cam 127a. For example, as shown, a pivot/swivel bearing or ball joint at the end of the link 127b may be attached to different portions of the cam 127a (e.g., by removing a bolt and placing the bolt into another threaded hole provided to the cam 127a). A linear bearing 127c may be employed at a top portion of column shaft 122 to allow reciprocating motion of the shaft 122. As shown, the adjustable drive 127 may comprise a ZX model drive sold by Plymouth, Minnesota-based Zero-Max, Inc., without limitation.

A contractor or other entity may provide a system having a mass transfer step and/or gravity settling step in part or in whole as shown and described. A contractor or other entity may provide a column settler in part or in whole as shown and described. For instance, the contractor may receive a bid request for a project related to designing a column settler system or process, or the contractor may offer to design such a system or a process for a client. The contractor may then provide, for example, any one or more of the devices or features thereof shown and/or described in the embodiments discussed above. The contractor may provide such devices by selling those devices or by offering to sell those devices. The contractor may provide various embodiments that are sized, shaped, and/or otherwise configured to meet the design criteria of a particular client or customer or work advantageously with a particular gravity settling system or column settler. The contractor may subcontract the fabrication, delivery, sale, or installation of one or more components of a gravity settling system or column settler, or of other devices used to provide such one or more components. The contractor may also survey a site and design or designate one or more storage areas for stacking the material used to manufacture the systems discussed herein. The contractor may also maintain, modify, or upgrade one or more provided or existing columns, mixer settler systems, or column extractor units, and/or components thereof. The contractor may provide such maintenance or modifications by subcontracting such services or by directly providing those services or components needed for said maintenance or modifications. In some cases, the contractor may modify an existing column, mixer settler system, or column extractor unit with a “retrofit kit” to arrive at a modified settling process, modified gravity settling system, or modified column having one or more of the process steps, devices, components, or features discussed herein.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

### REFERENCE NUMERAL IDENTIFIERS

100 System
101 Mass transfer step
102 Gravity settling step
103 First organic phase
104 First aqueous phase
105 Mixed unstable emulsion phase
106 Second stabilized organic phase
107 Second stabilized aqueous phase
110 Mixer
111 Organic inlet
112 Mixing shaft
113 Aqueous inlet
114 Impeller
115 Emulsion outlet
116 Mixer tank
120, 220, 320, 420, 520 Column Settler
121, 221, 321, 421, 521 Organic outlet
122, 132, 142, 152, 162, 422, 522 Gentle agitation shaft
222′, 322′ Inner gentle agitation shaft
222″, 322″ Outer gentle agitation shaft
123, 223, 323, 423, 523 Aqueous outlet
124, 134, 144, 154, 164, 224, 324, 424, 524, Baffle
624, 724, 824. 924
124a, 134a, 144a, 154a, 164a, 624a Solid portion
124b, 134b, 144b, 154b, 164b, 624b Open portion
125, 225, 325, 425, 525, 725 Emulsion inlet (e.g., volute entry)
126, 226, 326, 426, 526 Column tank
127, 227, 327, 427, 527 Transmission/gearbox
127a Cam
127b Link (e.g., with pivoting ends)
127c Bearing/bushing
128 Flanges
129, 229, 329, 429, 529 Motor
154c, 624c Second different open portion
157, 167, 667 Hub
159, 169 Baffle mount
470 Cylinder
471 Piston rod
701 First de-aeration/pre coalescence step
710 Pre-conditioner
704 De-aerated mixed unstable emulsion phase
705 Semi-coalesced emulsion phase
710 De-aeration device
801 Second de-aeration/pre coalescence step
810 Spiral downcomber/centrifugal coalescer

What is claimed is:

1. A mixer settler system [100] comprising:
a mixer [110] configured for receiving an organic phase and an aqueous phase, the mixer [110] being further configured to maintain the organic phase and the aqueous phase in a single unstable emulsion phase, wherein mass transfer occurs between said organic phase and said aqueous phase; and,
a column settler [120] which is configured to receive a single unstable emulsion phase from the mixer [110] via an emulsion inlet [125] and also configured to separate the single unstable emulsion phase into a stable organic phase and a stable aqueous phase by virtue of coalescence; the column settler further comprising an organic outlet [121] above the emulsion inlet [125] and an aqueous outlet [123] below the emulsion inlet [125]; the column settler [120] further discouraging mass transfers within the unstable emulsion phase and further promoting coalescence of each of said stable organic phase and stable aqueous phase;
wherein the column settler [120] is further provided with gentle agitation means; the gentle agitation means comprising a shaft [122] that moves and at least one baffle [124] attached to said shaft [122]; and,
wherein the gentle agitation means does not form an emulsion or facilitate mass transfer, but improves coalescence within the column settler [120].

2. (canceled)

3. (canceled)

4. The mixer settler system [100] according to claim 1, wherein the at least one baffle [124] is round.

5. The mixer settler system [100] according to claim 1, wherein the at least one baffle [134] is helical.

6. The mixer settler system [100] according to claim 1, wherein the at least one baffle [124] is flat.

7. The mixer settler system [100] according to claim 1, wherein the at least one baffle [144] is vertically oriented.

8. The mixer settler system [100] according to claim 1, wherein the at least one baffle [154, 164] is oriented at an angle.

9. The mixer settler system [100] according to claim 1, wherein the at least one baffle [124] comprises a solid portion [124a] and an open portion [124b].

10. The mixer settler system [100] according to claim 9, wherein the at least one baffle [124] comprises a plurality of open portions [124b].

11. The mixer settler system [100] according to claim 9, wherein the at least one open portion [124b] is round.

12. The mixer settler system [100] according to claim 9, wherein the at least one open portion [124b] is elongated.

13. The mixer settler system [100] according to claim 9, wherein the at least one open portion [124b] comprises a slot or slit.

14. The mixer settler system [100] according to claim 1, wherein the gentle agitation means comprises reciprocating means.

15. The mixer settler system [100] according to claim 14, wherein the reciprocating means comprises the shaft [122], wherein the shaft moves axially up and down within said column settler [120].

16. (canceled)

17. (canceled)

18. The mixer settler system [100] according to claim 1, wherein the gentle agitation means comprises slow rotation means.

19. The mixer settler system [100] according to claim 18, wherein the slow rotation means comprises the shaft [122], wherein the shall [122] slowly moves in clockwise or counter clock-wise direction within said column settler [120].

20. (canceled)

21. The mixer settler system [100] according to claim 18, wherein the slow rotation means comprises the shaft [122], wherein the shaft [122] slowly moves in a clockwise and then slowly in a counter clock-wise direction within said column settler [120].

22. (canceled)

23. The mixer settler system [100] according to claim 1, wherein the gentle agitation means comprises the shaft [122], slow rotation means, and reciprocating means.

24. (canceled)

25. (canceled)

26. A method of settling two immiscible liquids, the method comprising:
providing a mixer [110] configured for receiving an organic phase and an aqueous phase;
maintaining the organic phase and the aqueous phase in a single unstable emulsion phase using the mixer [110], wherein mass transfer occurs between said organic phase and said aqueous phase;
providing a column settler [120] which is configured to receive a single unstable emulsion phase from the mixer [110]; the column settler [120] being provided with gentle agitation means; the gentle agitation means comprising a moving shaft [122] and at least one baffle [124] attached to said shaft [122]; and
sending the single unstable emulsion phase to the column settler [120];
applying gentle agitation within the column settler [120] via said gentle agitation means;
separating the single unstable emulsion phase into a stable organic phase and a stable aqueous phase within the column settler [120] by virtue of coalescence;
discouraging mass transfers within the unstable emulsion phase after the unstable emulsion phase enters the column settler [120]; and,
promoting coalescence of each of said stable organic phase and stable aqueous phase in the column settler [120].

27. The method of claim 26, wherein the column settler [120] further comprises an organic outlet [121] above an emulsion inlet [125] and an aqueous outlet [123] below the emulsion inlet [125].

28. (canceled)

29. (canceled)

30. The method of claim 26, wherein the step of separating the single unstable emulsion phase into a stable organic phase and a stable aqueous phase within the column settler [120] by virtue of coalescence is performed using gravity.

31. (canceled)

32. The method of claim 26, wherein the step of applying gentle agitation within the column settler comprises reciprocation of the shaft [122], wherein the shaft [122] moves axially up and down within said column settler [120].

33. The method of claim 32, wherein the reciprocation of the shaft [122] further comprises the at least one baffle [124] moving axially up and down within said column settler [120].

34. The method of claim 33, wherein the at least one baffle [124] comprises one or more open portions [124b].

35. The method of claim 26, wherein the step of applying gentle agitation within the column settler comprises slowly rotating the shaft [122].

36. The method of claim 35, wherein the step of slowly rotating the shaft [122] comprises slowly rotating the shaft [122] in a clockwise and/or counter clock-wise direction within said column settler [120].

37. (canceled)

38. The method of claim 26, wherein the step of applying gentle agitation within the column settler comprises slowly rotating the shaft [122] clockwise and then slowly rotating the shaft [122] in a counter clock-wise direction within said column settler [120].

39. The method of claim 26, wherein the shaft [122] comprises an inner shaft [222′] and an outer shaft [222″]; and wherein the step of applying gentle agitation within the column settler comprises slowly rotating the inner shaft [222′] clockwise and simultaneously rotating the outer shaft [222″] counter-clockwise.

40. The method of claim 39, further comprising reversing the direction of the inner shaft [222′] and the outer shaft [222″].

41. The method of claim 39, wherein the inner shaft [222′] and/or the outer shaft [222″] comprises one or more baffles [224].

42. The method of claim 26, wherein the step of applying gentle agitation within the column settler [120] comprises both slow rotation and reciprocation of the shaft [122].

43. (canceled)

44. The method of claim 26, wherein the step of applying gentle agitation within the column settler [420, 520] comprises providing one or more stationary baffles [424, 524].

45. (canceled)

46. (canceled)

47. (canceled)

48. (canceled)

49. (canceled)

50. (canceled)
